(19) United States
(12) Patent Application Publication
(10) Pub. No.: US 2004/0001476 A1
(43) Pub. Date: Jan. 1, 2004

(54) Mobile application environment

(76) Inventors: Nayeem Islam, Palo Alto, CA (US); Shahid Shoaib, San Jose, CA (US)

Correspondence Address: BRINKS HOFER GILSON & LIONE, P.O. BOX 10395, CHICAGO, IL, 60611, US

(21) Appl. No.: 10/179,929

(22) Filed: Jun. 24, 2002

(51) Int. Cl. H04L 12/66

(52) U.S. Cl. 370/352

(57) ABSTRACT

In one aspect of the invention, a mobile application environment for a mervlet application is provided. The mobile application environment forms part of a mobile communication network comprising at least one access network. The environment comprises the mervlet, which includes instructions to create a web page with dynamically generated content. The mervlet is capable of executing on at least one of a local node and a remote node of the network. The environment also comprises a set of application attributes for the mervlet, including performance attributes characterizing the user interface of the mervlet. The environment further comprises a set of security attributes for the mervlet defining a security context in which to execute the mervlet. In addition, the environment comprises a mervlet engine that is operative to manage a lifecycle of the mervlet. The engine includes a core interpreter module operative to execute the mervlet in the security context defined by its security attributes. The engine also includes a policy module operative to determine whether to relocate the mervlet, the application attributes and the security attributes between the local and remote network nodes and to switch the access network using the application attributes to improve a user perceived performance of the mervlet. The environment next includes a cache manager agent operative to manage cache memory of the local and remote network nodes for receiving and storing the mervlet. Finally, the environment includes a messaging system operative to deliver content of the mervlet and the mervlet itself across the network.

### FIELD OF THE INVENTION

The present invention relates generally to a mobile application environment. In particular, it relates to a mobile application environment that can load balance mobile applications capable of creating dynamic web pages across heterogeneous mobile communication networks using a messaging system compatible with multiple low level transport protocols to optimize their user perceived performance.

### BACKGROUND

The need for mobile computing and network connectivity are among the main driving forces behind the evolution of computing devices today. The desktop personal computer (PC) has been transformed into the portable notebook computer. More recently, a variety of mobile handheld consumer electronic and embedded devices, including Personal Digital Assistants (PDAs), cellular phones and intelligent pagers have acquired relatively significant computing ability. In addition, other types of mobile consumer devices, such as digital television settop boxes, also have evolved greater computing capabilities. Now, network connectivity is quickly becoming an integral part of these consumer devices as they begin speaking with each other and traditional server computers in the form of data communication over various communication networks, such as a wired or wireless LAN, cellular, Bluetooth, 802.11 b (Wi-Fi) wireless, and General Packet Radio Service (GPRS) mobile telephone networks.

The evolution of mobile computing devices has had a significant impact on the way people share information and is changing both personal and work environments. Traditionally, since a PC was fixed on a desk and not readily movable, it was possible to work or process data only at places where a PC with appropriate software was found. Nowadays, however, the users of mobile computing devices can capitalize on the mobility of these devices to access and share information from remote locations at their convenience. A highly anticipated and powerful method for sharing information across a network of computers and mobile devices is via a Web interface for displaying dynamically generated content.

However, mobile devices pose several challenges for application developers. For example, mobile devices typically have more limited hardware resources than conventional computers. In addition, mobile devices tend to have widely varying hardware configurations, including differences in computation power, memory size, display capability, means for inputting data, etc. Mobile communication networks also experience limited network bandwidth and network availability. Consequently, mobile devices may be connected, intermittently connected or disconnected from a network.

Therefore, the first generation mobile devices typically were request-only devices or devices that could merely request services and information from more intelligent and resource rich server computers. The servers used standard software architectures, such as the Java 2 Enterprise Edition (J2EE) platform. The server platforms could define and support a programming model that allows thin-client applications to invoke logic instructions that execute on the servers.

Today, with the advent of more powerful computing platforms aimed at mobile computing devices, such as PocketPC and Java 2 Platform, Micro Edition (J2ME), mobile devices have gained the ability to host and process information and to participate in more complex interactive transactions. However, conventional mobile application platforms remain generally less robust than their server-based counterparts and fail to fully exploit the resources available on mobile devices. These platforms fail to satisfactorily load balance mobile applications at load time and runtime to optimize their user perceived performance, which can vary with the load on the network and the individual devices in the network. Also, they do not provide the services necessary to support multiple low level transport protocols for compatibility across heterogeneous mobile communication networks. Moreover, mobile devices using known application platforms cannot widely run server-based applications once disconnected from a network.

Therefore, in the area of mobile application environments for mobile devices there continues to be a need for a more robust application environment that offers improved services to support interactive mobile applications with richer functionality.

### SUMMARY

In one aspect of the invention, a mobile application environment for a mervlet application is provided. The mobile application environment forms part of a mobile communication network comprising at least one access network. The environment comprises the mervlet, which includes instructions to create a web page with dynamically generated content. The mervlet is capable of executing on at least one of a local node and a remote node of the network. The environment also comprises a set of application attributes for the mervlet, including performance attributes characterizing the user interface of the mervlet. The environment further comprises a set of security attributes for the mervlet defining a security context in which to execute the mervlet. In addition, the environment comprises a mervlet engine that is operative to manage a lifecycle of the mervlet. The engine includes a core interpreter module operative to execute the mervlet in the security context defined by its security attributes. The engine also includes a policy module operative to determine whether to relocate the mervlet and the application attributes between said local and remote network nodes and the security attributes among computing devices in the network and to switch the access network using the application attributes to improve a user perceived performance of the mervlet. The environment next includes a cache manager agent operative to manage cache memory of the local and remote network nodes for receiving and storing the mervlet. Finally, the environment includes a messaging system operative to deliver content of the mervlet and the mervlet itself across the network.

### BRIEF DESCRIPTION OF THE DRAWINGS

The accompanying drawings, which are incorporated in and constitute a part of this specification, illustrate embodiments of the invention and, together with the description, serve to explain the advantages and principles of the invention. In the drawings,

FIG. 1 is a block diagram showing the system components of a Mervlet application environment according to the present invention;

FIG. 2 is a flow chart showing the details of the operation of the Mervlet application environment of FIG. 1;

FIG. 3 is block diagram showing a high level view of a mobile communication network for the Mervlet application environment of FIG. 1;

FIG. 4 is a block diagram showing the structure of a Mervlet application and its attributes for the Mervlet application environment of FIG. 1;

FIG. 5 is a block diagram showing the lifecycle of a Mervlet application for the Mervlet application environment of FIG. 1;

FIG. 6 is a block diagram showing the steps in and overall structure of the Mervlet engine for the Mervlet application environment of FIG. 1;

FIG. 7 is a block diagram showing a timeline for user interface events for the Mervlet application environment of FIG. 1;

FIG. 8 is a table summarizing the performance attributes and system attributes for the Mervlet application environment of FIG. 1;

FIG. 9 is a flowchart showing details of the application provisioning optimization for load balancing a Mervlet for the Mervlet application environment of FIG. 1;

FIG. 10 is a flowchart showing details of the network switching optimization for load balancing a Mervlet for the Mervlet application environment of FIG. 1;

FIG. 11 is a block diagram showing the interface between a reliable message system and a Mervlet engine for the Mervlet application environment of FIG. 1;

FIG. 12 is a diagram showing the structure of a message for the reliable messaging system of FIG. 11;

FIG. 13 is a chart showing details of the operation of the reliable messaging system of FIG. 11; and

FIG. 14 is a table showing different configurations and the associated performance costs for the reliable messaging system of FIG. 11.

### DETAILED DESCRIPTION OF THE PREFERRED EMBODIMENTS

Reference will now be made in detail to an implementation of the present invention as illustrated in the accompanying drawings. The preferred embodiments of the present invention are described below using a Java based software system. However, it will be readily understood that the Java based software system is not the only vehicle for implementing the present invention, and the present invention may be implemented under other types of software systems.

1. Overview of the Mervlet Application Environment

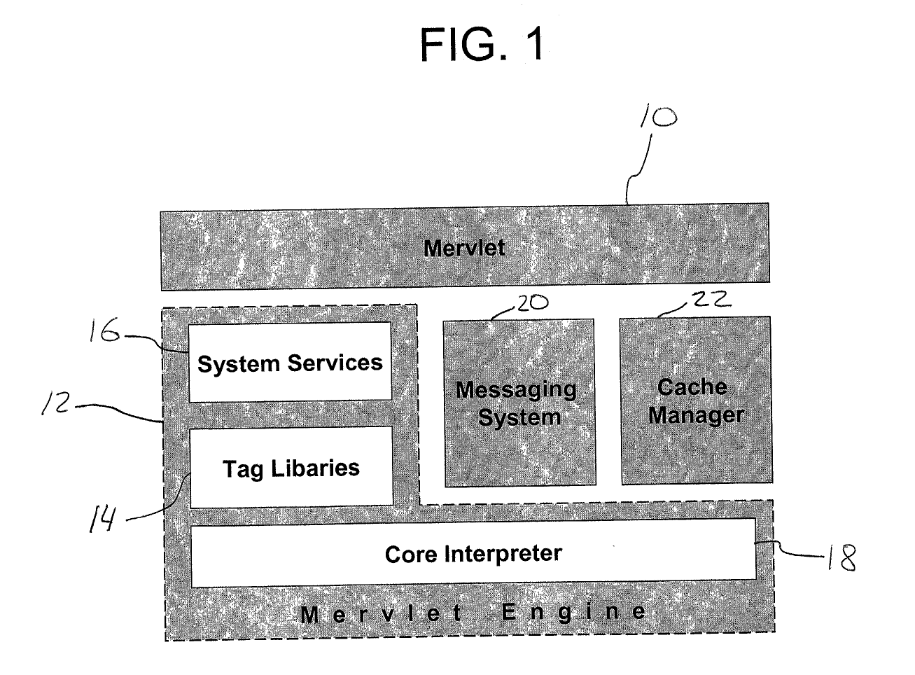

In an application environment according to the present invention, shown in FIG. 1, application developers create mobile applications (“Mervlets”). A Mervlet 10 is an executable application program capable of creating dynamic web pages for mobile computing devices. A Mervlet 10 comprises uninterpreted code that includes both user interface logic for creating a web page and application logic for generating dynamic content for the page. A Mervlet 10 can further comprise local static data and can access data files, such as ASCII text files. Moreover, unlike conventional application programs, a Mervlet 10 has a unique set of application attributes that are associated with it. These attributes make it possible to dynamically load balance a Mervlet 10 at load time and runtime across a communications network. A Mervlet 10 also can run in its own security context on various devices in a network using the same set of security attributes associated with the Mervlet. Accordingly, a Mervlet 10 has the features of a relocatable dynamic web document.

Mervlets execute under the control of a Mervlet runtime engine 12, which includes customized tag libraries 14, a set of components for system services 16 and a core interpreter 18. The Mervlet engine 12 may be configured to be self-recoverable so that it is able to restart execution of a set of Mervlets that were running at the time of a system failure.

The Mervlet engine 12 can use a messaging system 20 to deliver content across a network to a client device from a Mervlet that is executing remotely or to deliver Mervlets themselves for load balancing. For example, the Mervlet engine can use point to point asynchronous messaging to communicate requests to and replies from a Mervlet and also to transmit the Mervlet itself. In addition, the Mervlet application environment supports a reliable messaging system that can recover from transient network and device failures and guarantee the delivery of a message to its endpoint. The reliable messaging system can be configurable to allow a user to choose a device for buffering messages for different recovery options. Those skilled in the art will readily recognize that other messaging systems could be used, including systems that use remote procedure calls transported by HTTP, SMTP or a similar transport protocol.

The Mervlet engine 12 can also interface with a configurable cache manager 22 for caching Mervlets locally on a device to hide network disconnections. If a device cache is programmable, then Mervlet specific caching policies can be downloaded to the device. The caching mechanism allows the cache manager to dynamically change its cache management policies.

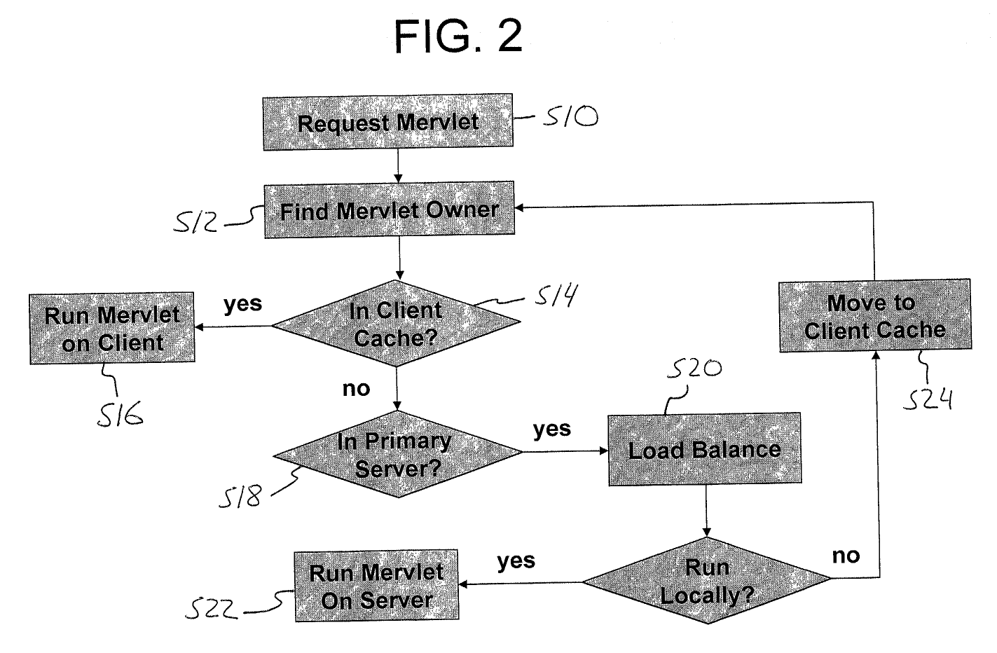

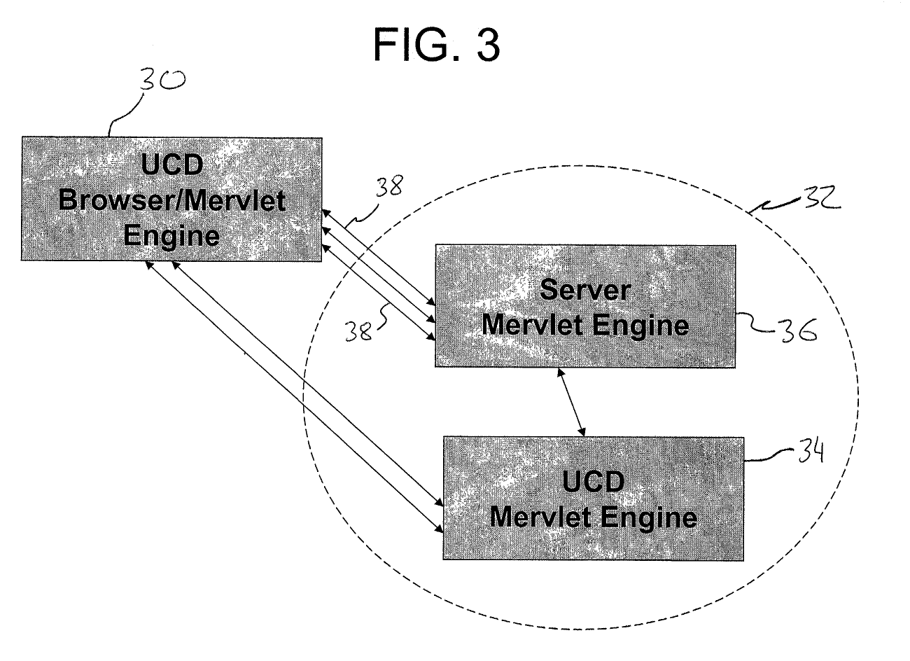

Referring next to FIGS. 2 and 3, in operation, a mobile device or user client device (UCD) 30 forming part of a communications network generates a request for a Mervlet 10 in step 10. The UCD 30 runs the Mervlet application environment and can display information using a web browser, such as Internet Explorer and Pocket Internet Explorer from Microsoft Corp. and Netscape Navigator from Netscape Communications Corp. The UCD 30 generates a request for the Mervlet 10 using a Uniform Resource Identifier (“URI”). The URI encodes the name and address of an object, including a Mervlet, in a registered name space on the network to allow access to the object using an Internet access protocol. The requesting UCD 30 may be able to execute the Mervlet 10 locally or obtain content from the Mervlet 10 when it is executing remotely.

The requested Mervlet 10 may be stored locally on the requesting UCD 30 or on a remote node of the network with sufficient memory and processing capacities to execute the Mervlet (“primary server”) 32, which may be another UCD 34 or a computer server class device 36. The requesting UCD 30 can locate a primary server 32 using existing resource discovery techniques, such as JINI from Sun Microsystems, in step 12. The primary server 32 must be able to execute the Mervlet 10 or locate a secondary server, not shown, on the network to execute the Mervlet 10. In the latter case, the primary server 32 must send the Mervlet 10 to the secondary server and forward the request from the requesting UCD 30. The UCD 30 and the primary server 32 may communicate over one or more access networks 38.

The requesting UCD 30 first checks to see if the Mervlet 10 is stored in a local cache on the device in step 14. If it is, then the Mervlet 10 is executed there and then in step 16. Otherwise, the requesting UCD 30 communicates with the primary server 32 to get “access” to the requested Mervlet 10 in step 18. The primary server 32 then invokes a load balancing policy on the Mervlet 10 in step 20 to optimize the user perceived performance of the Mervlet 10. For example, the primary server 32 may decide to run the Mervlet 10 locally (step 22) or to relocate it to the requesting UCD 30 (step 24). In some cases, the UCD 30 may make an explicit request to run the Mervlet 10 at its site. However, the primary server 32 can ignore that request. If the Mervlet 10 is executed on the primary server 32 in step 22, the result is transmitted back to the UCD 30 via the messaging system of the Mervlet application environment.

The primary server 32 can determine whether to run the Mervlet 10 locally or on the requesting UCD 30 based on several attributes, including: 1) the memory and processing capacities on the UCD and server nodes, 2) the load on each of the two nodes and the network bandwidth and latency, and 3) a set of attributes relating to the performance of the Mervlet. For example, the server may determine to run the Mervlet on the UCD if the Mervlet is highly user interactive, for example a gaming application, and the UCD has sufficient hardware resources to execute the Mervlet. On the other hand, if the Mervlet is data or computationally intensive rather than interactive, for example a personalization application, then the server may determine to run the Mervlet itself. However, those skilled in the art will clearly recognize that other load balancing decisions are also possible based on the parameters that the system monitors. For example, the primary server 32 and the UCD 30 can implement a network switching policy to switch access networks 38 between the devices for improved communication.

A system implementation that supports the high level execution model described above will now be described. In particular, several key properties of the Mervlet application environment will be explained, including: 1) the application model for a Mervlet, 2) the Mervlet runtime engine, 3) load balancing schemes for optimizing the user perceived performance of a Mervlet across a network, 4) configurable fault tolerance schemes for a recoverable Mervlet engine and reliable messaging system, and 5) configurable disconnected mode operation schemes.

2. Mervlet Application

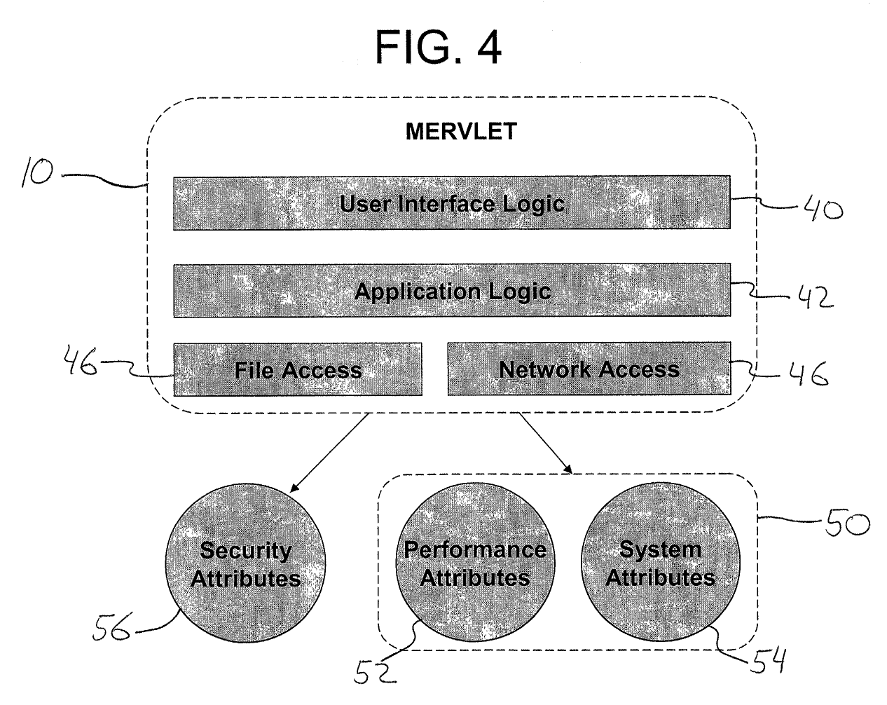

A Mervlet 10 defines the user interface for a web page to display dynamically generated content on a mobile device. The structure of a Mervlet 10 is shown in FIG. 4. In particular, the Mervlet 10 uses platform independent user interface logic 40 such as markup language instructions to control the formatting and display a web page. It can also handle requests and replies from a web browser. For example, a Mervlet can support web pages using static HTML, DHTML, XHTML, XML and similar formatting tags that can be interpreted by a web browser. In addition, the Mervlet 10 uses XML-like tags to encapsulate application logic 42 that generates the dynamic content for the web page. The application logic 42 itself can reside in server-based resources that the web page accesses with these tags, such as JavaBeans or customized Mervlet tag libraries. Mervlet tag libraries may be native to the application environment on a particular device or they may move with a Mervlet when a Mervlet is relocated during load balancing. Therefore, the Mervlet 10 separates the user interface of a dynamic web page from content generation for a reusable component-based design that is platform independent.

The Mervlet 10 can make network connections via the messaging system 20 and can access local data files. Therefore, the application model for a Mervlet includes user interface logic 40, application logic 42, file access 46 and network access 44.

In addition, a set of novel application attributes 50 comprising performance attributes 52 and system attributes 54 are associated with the Mervlet 10 for dynamically load balancing the Mervlet in a network. For example, the Mervlet 10 may be dynamically relocated at load time and run time across a mobile communications network using its application attributes 50, as described further below.

The Mervlet 10 also can execute in its own security context based on a set of associated security attributes 56. A containment model determines what resources are available to a user. Using a variant of the Java 2 security model, a class loader and affiliated classes are modified with a policy mechanism discussed in “A flexible security model for using internet content,” Islam et al, IEEE Software, 1997, which is incorporated herein by reference, with the exception that a protection domain may be set by the UCD. The class loader creates a security context in which to run the Mervlet 10. Mervlets are signed and verified by a device before they are run. A policy module configured using the security attributes 56 implements policy for who to trust and what operations are allowed. The Mervlet engine 12 can monitors at runtime any access by the Mervlet 10 and kills the Mervlet if it attempts to run outside of its security context. The security context for a Mervlet 10 can be moved and recreated on different devices in a network by relocating the security attributes 56 along with the Mervlet 10.

These features are peculiar to the Mervlet application model and elude other types of technologies for creating dynamic web pages such as JavaServer Pages (“JSP”) discussed in “JavaServer PagesTM—White Paper,” Sun Microsystems, which is available via URL http://java.sun.com/products/jsp/whitepaper.html and is incorporated herein by reference.

A Mervlet 10 can be implemented as a Java application component derived from the JSP model. Such a Mervlet implementation can access the J2ME CDC environment and the resource files used by Java classes, except that it does not have access to JNDI, JMS, JTA, JAF, Java Mail, RMI, JDBC and IIOP classes. In addition, the JSP derived Mervlet does not have access to AWT or SWING classes. The J2ME based implementation of the Mervlet also disallows scripts inside a web page processed by the Mervlet. These restrictions may exist on all nodes of a network that implement the Mervlet application environment in order to optimize the Mervlet implementation for thin client devices having limited hardware resources. Accordingly, Mervlets are platform-independent and can leverage existing Java platform technologies while meeting thin client requirements.

The J2ME based implementation of the Mervlet application environment according to the present invention changes the semantics of traditional JSP and Servlet execution, such as determining when and where to execute Mervlets, instead of solely making changes to the JSP application programming interfaces (“APIs”). This implementation will now be described in greater detail below.

3. The Mervlet Engine

A Mervlet 10 is compiled and executed on a Mervlet engine 12, as shown in FIG. 1. The engine 12 can process requests from a client application such as a web browser to the Mervlet 10 and generate responses from the Mervlet 10 to the client browser. In particular, the Mervlet engine 12 interprets the Mervlet tags for the application logic 42 and generates corresponding dynamic content by accessing a resource or tag library, which could be native to the device or relocatable with a Mervlet 10. The engine 12 then sends the results back in the form of an HTML or XML page to the requesting web browser. Any static formatting tags are passed directly to the requesting web browser.

The Mervlet engine 12 can run on the J2ME CDC platform for thin client devices and the J2EE platform for server class devices. The J2ME platform traditionally requires a 32 bit CPU and at least 2 megabytes of memory. The J2EE platform traditionally requires at least an Intel Pentium III class processor, 128 megabytes of RAM memory, and 300 megabytes of persistent storage. One possible configuration for a Mervlet application environment according to the present invention that supports a Mervlet engine 12 that consumes up to 6 megabytes at runtime would include at least a 32 bit CPU, 10 megabytes of RAM memory, and 40 megabytes of persistent storage. However, it should be understood that these values for the Mervlet application environment are meant to be illustrative, rather than limiting. In the context of J2EE, the Mervlet engine 12 can replace the web container and Servlet engine models in J2EE. Therefore, the Mervlet engine 12 can provide a Mervlet 10 with access to Java Virtual Machine (JVM), PersonalJava Virtual Machine (PJVM) or other type of Virtual Machine (VM). VM, which runs on top of the native operating system of a device, acts like an abstract computing machine, receiving Java bytecodes and interpreting them by dynamically converting them into a form for execution by the native operating system.

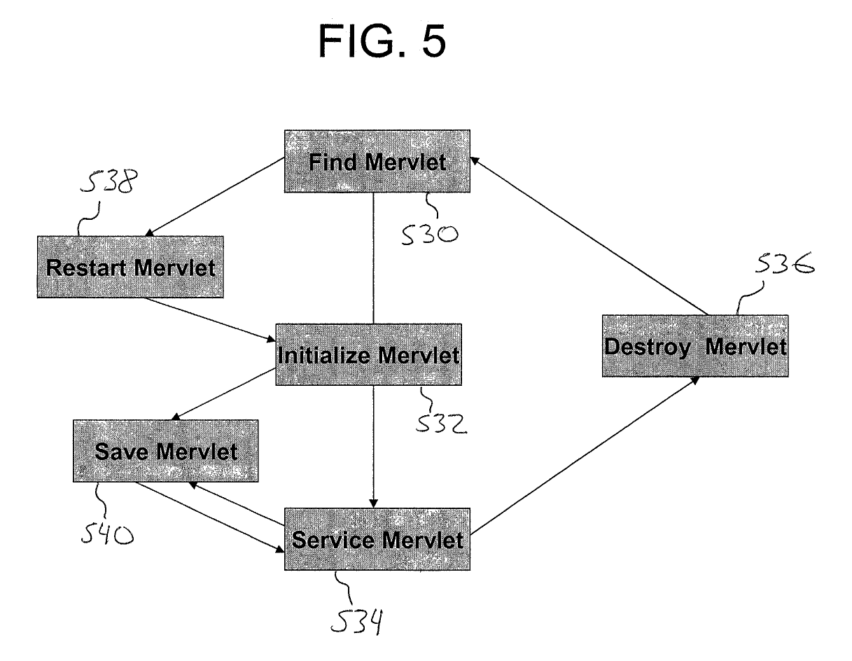

A Mervlet engine 12 manages the lifecycle of a Mervlet 10 via a set of application programming interfaces (APIs), as shown in FIG. 5. The actions that the Mervlet engine performs include finding the Mervlet requested by a client application on a network in step 30. The requested Mervlet may be stored either on the requesting client or on a primary server. After the Mervlet is found, the Mervlet engine creates an instance of the Mervlet, loads it into the engine's memory and initializes it in step 32. Once initialized, the Mervlet is ready to receive information and the Mervlet engine can pass requests and process replies from the Mervlet in step 34. Once the Mervlet is no longer needed, the Mervlet engine destroys the Mervlet and removes its presence from the engine memory and any data in persistent storage associated with the Mervlet in step 36.

The Mervlet engine can restart a Mervlet after a crash in step 38. The Mervlet engine may also notify a Mervlet at any time that it needs to save its state in step 40. The ability of the Mervlet engine to recover from a crash using these actions is described in further detail below in connection with the fault tolerance for the Mervlet application environment.

The following are an exemplary set of APIs for implementing Mervlets on a Mervlet engine based on the J2ME platform. The Mervlet APIs are derived from the standard Java classes for interfaces for Java Servlets. The Mervlet implementation creates a “javax.mervlet” subclass of the “javax.servlet” class.

There are ten classes to consider for the “javax.mervlet” implementation of the Mervlet API. Five of the ten classes that remain unchanged from the Servlet implementation are listed below.

Mervlet Exception, which is identical to ServletException

MervletInputStream, which is identical to ServletInputStream

MervletOutputStream, which is identical to ServletOutputStream

RequestDispatcher, which remains unchanged

MervletConfig, which is identical to ServletConfig

There are also five classes that require modified semantics as described below.

Mervlet

MervletContext

MervletRequest

MervletResponse

SingleThreadModel

The class “Mervlet” has three important methods:

public void init( ) throws “MervletException”;
public void service( ) throws “MervletException”; and
public void destroy( ) throws “MervletException”;

The method “init( )” is called by the Mervlet engine to initialize the Mervlet. It must be called after the Mervlet is found and a class loader has been invoked on the Mervlet. The method “init( )” must be called before any calls to the method “Service( )” are allowed. The method “service( )” is called on the Mervlet to allow the Mervlet engine to pass requests and process replies from the Mervlet. The Mervlet is destroyed by calling the method “destroy ( )” on the Mervlet.

In the case where a parameter is required, a Mervlet context is constructed and passed in to the method. Therefore, developers can extend the class “Mervlet” and override the methods “init( )” and “service( )”, for example, as follows:

public void init(MervletConfig) throws “MervLetException”;
and
public void service(MervletRequest, MervLetResponse) throws

IOException, MervletException.

In addition, the following two additional methods are available as part of class “Mervlet” for load balancing a Mervlet relocation or recovering from system failures:

void Restore(MervletContext m)
void Save( )

The method Restore( ) is called by a Mervlet engine prior to the method init( ) to restore its own state when attempting to recover Mervlets following a crash. The method Save( ) may be called by a Mervlet engine at any time to notify a Mervlet to save its application state. However, Mervlets should not assume that the method Save( ) will be called prior to a crash.

The class “MervletContext” specifies resources available to a Mervlet. It is an extension of the class “ServeletContext” and includes the following additional resources: i) files for use with the Mervlet; ii) a set of attributes relating to the performance of the Mervlet, including user interface and I/O characteristics as described further below; and iii) resource rights for the Mervlet. The class “MervletContext” also includes methods to get and set each of these resources.

The classes “MervletRequest” and “MerveletResponse” are extensions of the classes “ServeletRequest” and “ServeletResponse” respectively. The Mervlet engine generates requests and responses using the following abstract messaging method:

void Reliable_async_send(Endpoint to, Endpoint From, DataStream

Data, Reliability Type, CallbackMethod cm).

The data format for this method is the same as that for HTTP-mime encoded interfaces. Other implementations are possible with different exchange formats.

The class “SingleThreadModel” from the Servlet model is not implemented because the Mervlet engine is multithreaded.

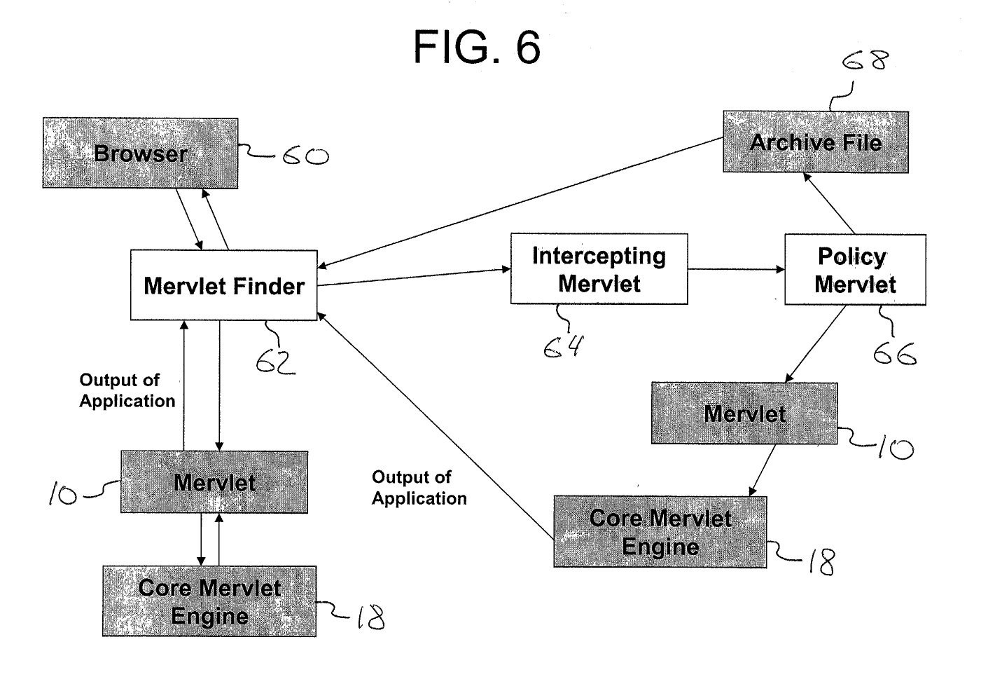

Referring next to FIG. 6, the functional block diagram showing the operation of the Mervlet engine 12 in response to a request for a Mervlet 10 from a client application or browser 60 on a user client device 30 is now described. First, the Mervlet engine 12 on the requesting client 30 must find the Mervlet 10. The engine itself is constructed from simple Mervlet components. In order to locate or find the requested Mervlet, a “MervletFinder” module 62 intercepts all calls in the client 30 that request to load Mervlets. The module MervletFinder 62 searches the local cache on the client 30 for the Mervlet 10 that has been requested using known hash functions exported by the cache. If the Mervlet 10 is found, the module MervletFinder 62 allocates memory for the Mervlet and reads in the Mervlet from the local cache. The module MervletFinder 62 then calls the method “init( )” on the Mervlet 10, passing the configuration data for the requested Mervlet to initialize the newly created instance of the Mervlet. When the Mervlet 10 is finished, it calls the method “destroy( )” on itself. If the Mervlet engine 12 wants to remove the Mervlet 10, it can call the method “destroy( )” on it.

If the module MervletFinder 62 determines that the requested Mervlet 10 is not on the client 30 because there was no match in the local cache, then it queries a primary server device 32 for the Mervlet 10. The query to the server 32 contains the name of the Mervlet 10, the CPU utilization on the client device 30, the MIPS rating of the client device 30, the available memory and the persistent storage on the client device 30, and any performance attributes of the Mervlet 10 if available. This information may be used by the primary server 32 to determine whether to relocate the Mervlet 10 to the client 30 or switch access networks 38 for communication between the server 32 and client 30 using a load balancing scheme described below in further detail.

The Mervlet engine 12 also includes a module “InterceptingMervlet” 64, which intercepts requests for the Mervlet 10 arriving at the primary server 32. When requests arrive for the Mervlet 10 from the network, the module InterceptingMervelt 64 dispatches the messages to the Mervlet 10 on the server 32. In response to a request for the Mervlet 10, the module InterceptingMervlet 64 also calls a module “PolicyMervlet” 66 and passes the system performance parameters for the requesting client 30 to it. The module PolicyMervlet 66 then determines how to load balance the Mervlet 10 to optimize its user perceived performance. The module PolicyMervlet 66 is set by a system administrator. In addition, the primary server 32 may entertain multiple requests from clients simultaneously and hence the modules PolicyMervlet 66 and InterceptingMervlet 64 are multi-threaded.

In particular, the primary server 32 and the client 30 can load balance the Mervlet 10 as follows. The server 32 can choose to execute the Mervlet 10 on the server machine and let the requesting client interact 30 with the Mervlet remotely. Alternatively, the server 32 can decide to send the Mervlet 10 to the client 30 for execution on the client device. The module PolicyMervlet 66 determines whether to relocate the Mervlet 10 using an application provisioning scheme, which is described below in further detail. In addition, either the server 32 or the client 30 may choose to switch access networks 38 for communicating with each other using a network switching scheme, which is described in further detail below.

If the server 32 decides to run the requested Mervlet 10 on the server machine, then the module PolicyMervlet 66 retrieves the Mervlet 10 from the server's cache and allocates memory for it using a method “new( )”. Then, the method “init( )” is invoked on the Mervlet 10 using the appropriate Mervlet context. The initialized instance of the Mervlet 10 assumes the credentials of the requesting client when the semantics of security are the same as those in J2EE. After the instance of the requested Mervlet 10 has been initialized, it can access local data on the server. The Mervlet 10 can also communicate with client applications on the client 30 through the messaging system 20, as described below in further detail. Accordingly, the Mervlet engine 12 sends the output from the Mervlet 10 directly to the requesting client 30. Finally, the Mervlet 10 can be destroyed by calling the method “destroy( )” on the Mervlet.

If the module PolicyMervlet 66 determines that the requested Mervlet 10 should run on the requesting client 30, then the Mervlet is marshaled and sent to the remote machine. In order to relocate the Mervlet 10, the engine 12 packages the Mervlet into a Mervlet archive (“MAR”) file 68. The MAR file 68 preferably comprises 1) the Mervlet 10 and any associated tag libraries 14, 2) the security context attributes 56 and application attributes 50 for the Mervlet, 3) any data files associated with the Mervlet 10, and 4) a MAR file manifest describing the contents of the MAR file. Therefore, the MAR file 68 has all the information necessary for the Mervlet engine 12 on the client 30 to create the appropriate Mervlet context to pass to the method “init( )” of the Mervlet 10 when it is started. The MAR file 68 may be compressed, hashed and then signed. A downloader may uncompress and verify that the content has not been corrupted and verify the signature.

We now explain how the Mervlet application environment may load balance a Mervlet application and recover from system failures.

3. Application Load Balancing Scheme

One feature of the Mervlet application environment, which will now be described in greater detail, allows the Mervlet engine 12 to load balance a Mervlet 10 to optimize the performance of the Mervlet.

The load balancing scheme is based on user interactions with a user client device 30 that is requesting the Mervlet 10 from a server 32. In particular, the module PolicyMervlet 66 of the Mervlet engine 12 uses measures of the event wait times for the user interface (“UI”) of the client to optimize the perceived performance of the Mervlet 10. The Mervlet application environment according to the present invention allows load balancing to be performed at application request time and at application runtime.

The load balancing scheme according to the present invention allows two types of optimizations: application provisioning and network switching. An application provisioning policy allows the server to determine which node of the network to run a Mervlet on. A network switching policy allows either the requesting client or the server to choose a new access network for communication between the server and the client. This model allows a developer to create a large class of algorithms for load balancing.

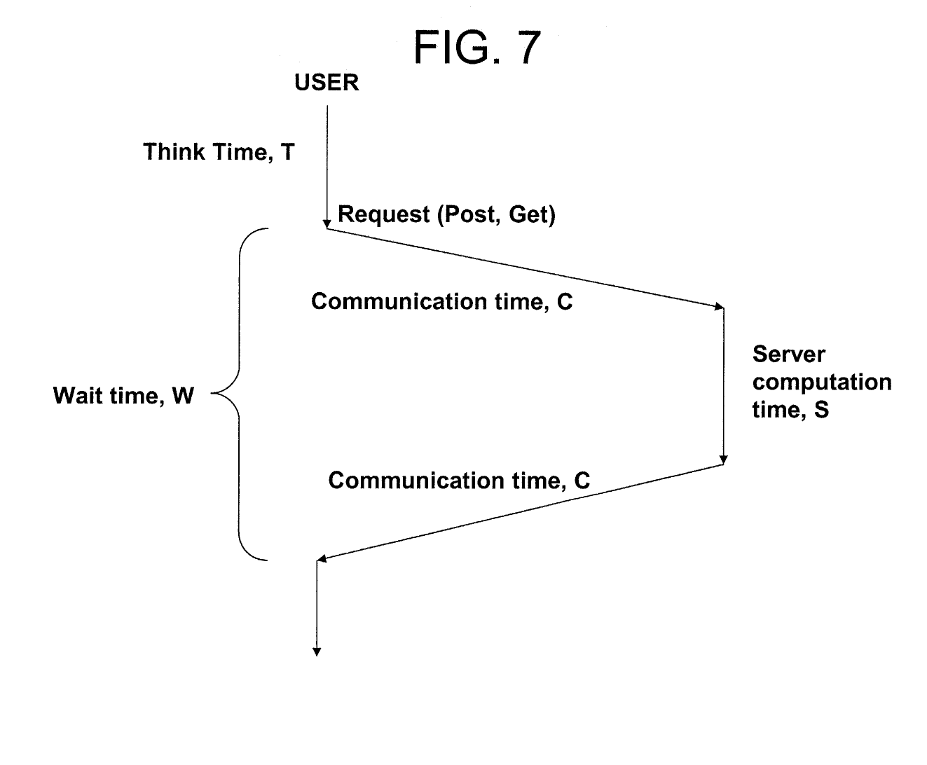

In order to explain the performance optimization made possible using the load balancing scheme, a timeline for user interface events on a client device is shown in FIG. 7. A user moves through alternate think and wait times during user interactions with a Mervlet. At the end of each think time T, the user sends a request to a Mervlet and waits for a reply. The Mervlet typically waits in a loop for requests from the user. On receiving a request, the Mervlet may perform computations and data access to fulfill the user's request. It will then send back the reply. The timeline shown in FIG. 7 completes one such interaction.

The wait time W is the time associated with processing a request. The wait time W can be broken down into communication time C and server computation time S. Typically, user experience is based on the mean and variance of the wait times when interacting with the application. Therefore, the performance of a Mervlet can be optimized if its wait times are generally below a predetermined threshold value. The load balancing scheme according to the present invention can optimize the mean and variance of the wait times for a Mervlet by relocating the Mervlet from the server closer to the user or switching the access network between the client and the server when appropriate.

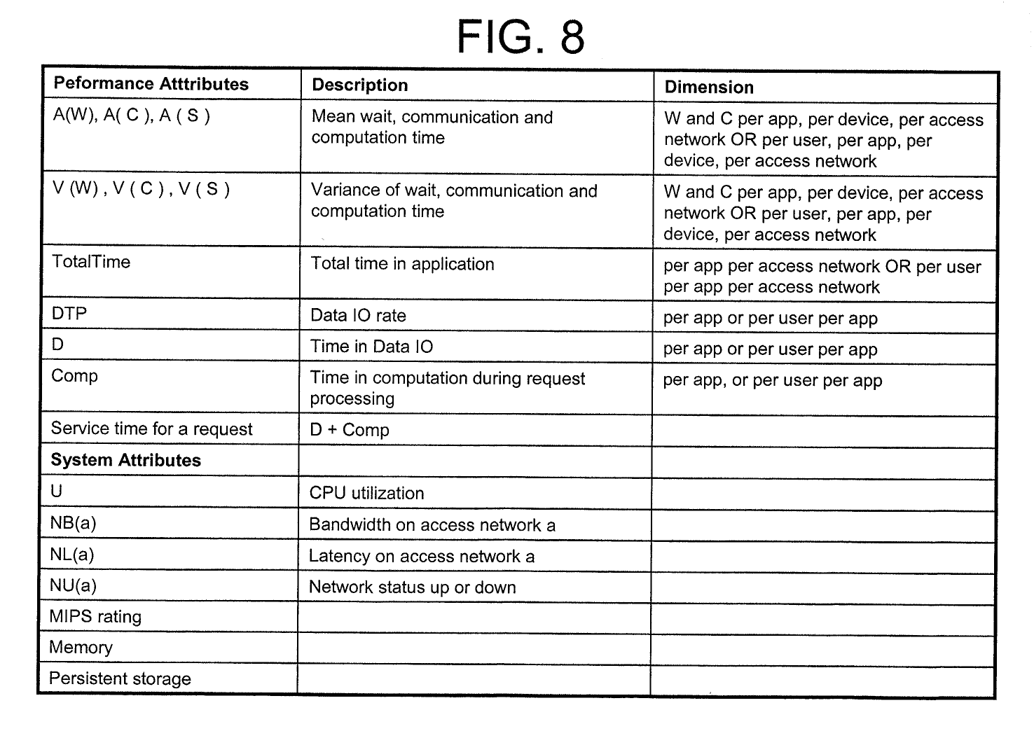

In order to load balance a Mervlet 10, the module PolicyMervlet 66 of the Mervlet engine 12 utilizes a set of application attributes 50 comprising performance attributes 52 and system attributes 54, which are summarized in FIG. 8 and described in more detail below.

3.1 Mervlet Performance Attributes

The application attributes 50 used to load balance a Mervlet 10 include a set of performance attributes 52 that characterize the Mervlet based on two criteria: 1) how interactive the application is, and 2) how computationally and data intensive the application is. Intuitively, developers want to provide the system with the ability to move interactive applications closer to the user, to move data intensive applications closer to the source of the data, and to allow a computationally intensive application to run on more powerful devices such as server class machines. Typically, developers write Java applications as either server applications on J2EE, for example JSPs and Servlets, or as applets for clients. For example, one would traditionally write a game as an applet and a banking application as a server based application. On the other hand, Mervlet developers only need to write the application once, and then the PolicyMervlet 66 can utilize measured performance attributes 52 to relocate the Mervlet 10 closer to the user or switch access networks to provide better mean and variance wait times for the Mervlet.

3.1.1 Characterizing Mervlet Interactions

In particular, users wait for events when they interact with a client device 30 and request information from a Mervlet 10, for example when they post web page forms and click on URLs for information. These actions, including the act of filling in a form and waiting for a response and the act of clicking on a link and getting a page, are referred to as user interface events. When the Mervlet 10 runs on the client device 30, all of the wait time W is spent in the application. If the Mervlet 10 is executing remotely from the client device 30 on a server 32, part of the wait time W is spent communicating with the requesting client, C, while the remainder of the wait time is spent in the Mervlet itself for processing of the client request, S.

In order to load balance a Mervlet 10, the Mervlet application environment measures the following performance attributes of the Mervlet for each form and URL sending a request to it: the mean and variance of the wait time W, the server computation time S and the communication time C.

For example, an HTML based client can intercept all “gets” and “posts” from the browser on the client to a Mervlet. This is handled by the module InterceptingMervlet of the Mervlet engine. When a “get” or “post” is performed, a first timestamp T1 is taken. When the “get” or “post” returns and the reply generated by the Mervlet is displayed on the browser, a second timestamp T2 is taken. Also, the reply message from the Mervlet includes a parameter value indicative of the time spent in computation in the server S. Accordingly, the following calculations can be made:

W=T2−T1;

and

W=S+C,

where

S=Server computation time;

C=Communication time;

W=Wait time;

T1=First time stamp; and

T2=Second time stamp.

The server 32 maintains a running average of the mean and variance of the server computation time, wait time and communication time, denoted by A(S), A(C), A(W), and V(S), V(C), and V(W) respectively. In addition, a running average of the mean and variance of the W and C parameters are calculated for each access network used to communicate between the requesting client and the server.

If the C and S parameters are continuous random variables, the following relationships can be assumed:

A(W)=A(C)+A(S);

and

V(W)=V(C)+V(S)+Cov(V,S),

where

Statistical Covariance for V and S=Cov(V,S).

Moreover, if V and S are statistically independent variables, then the following relationship holds:

V(W)=V(C)+V(S)

Therefore, a load balancing policy for a Mervlet 10 can improve a user's perception of the Mervlet's performance by reducing A(C) and V(C).

For example, a framework for an algorithm to implement the application provisioning optimization could determine whether the wait time W for the Mervlet 10 is unacceptable by verifying if A(W) is greater than a predetermined threshold value. Also, it could determine whether the communication time C is having an appreciable impact on the wait time W by verifying that A(C) is greater than the A(S). If W is unacceptable and C is appreciable, then the algorithm could attempt to relocate the Mervlet to another device. Otherwise, the Mervlet continues to run on the present device.

Likewise, an algorithm framework that could be used to implement the network switching optimization determines whether the mean wait time for a Mervlet 10 using a first access network, A(W-network1), is greater than the mean wait time using a second access network, A(W-network2). If so, the algorithm will switch to the second network, network2, for communication to and from the Mervlet.

Those skilled in the art will recognize that other optimization algorithms for load balancing a Mervlet 10 are possible using the performance attributes 52. The load balancing scheme provides the opportunity for an application designer to create different algorithms to improve user experience and optimize the perceived performance for user interface events.

3.1.2 Characterizing Server Computation Time and Data Access

As noted above, the total service time for a Mervlet to generate a reply to a single request from a client application is measured by the server computation time S. A Mervlet may spend server computation time S performing internal calculations and also accessing external data files, such that:

S=D+I,

where

S=Server computation time;

D=Time spent for data I/O; and

I=Time spent for internal calculations.

In order to obtain values indicative of the server computation time, S, a timer on the server is started when the Mervlet engine on the server calls the method “service( )” on a Mervlet in response to a request from a client applications. When the Mervlet generates a reply to the request, the timer is stopped. The duration for the timer measures the server computation time, S. The I/O libraries for the Mervlet engine are instrumented to record the time spent in data I/O, D, and the data I/O rate, DTP. The time spent for internal calculations, I, can be calculated from the equation above.

The Mervlet engine can also record the average total time for the Mervlet to run to completion, TotalTime, using a timer on the server. These parameters are made available to Mervlet developers to refine the load balancing algorithms discussed in more detail below.

3.1.3 Performance Attribute Instrumentation

The following are an exemplary set of APIs for intercepting user interface and file I/O events of a Mervlet 10 using J2ME libraries. These APIs require the following modifications to the libraries java.net, jave.io, and java.util.

The performance attributes 52 for measuring user interface events of a Mervlet 10, including the wait time W, the server computation time S and communication time C, are determined by modifying java.net to intercepts all http requests. The following method is used to collect information on HTML based forms and URL processing, as described above:

void recordEvent( EventType et, Event e, TimeStamp t)

Each request/reply pair with a form is recorded and all the events in the form are counted using this method.

Additionally, the following method for data file read and writes is provided:

void _recordFileIO(AccessType type, int data, Timestamp time)

The data type for the parameter AccessType can be either read or write type. This method writes the measured performance attributes to a file.

3.2 System Attributes

The PolicyMervlet 66 also uses system attributes 54 in addition to application attributes 54 for load balancing and network switching decisions. The system attributes 54 relate generally to the resources and processing power of the computing devices used by the Mervlet application environment. In particular, as shown in FIG. 8, the following attributes are recorded for each client 30 and server 32: the MIPS rating, mean and variance of CPU utilization, the size of memory and persistent storage, and the mean and variance of network latency and bandwidth for each network type available at the device.

3.2.1 System Attributes through Instrumentation

In order to measure the system attributes 54, a new library for the J2ME platform, java.sys.perf, makes available the following methods:

void System_cpu_util(UtiI U)

The method System_cpu_util(Util U) reads/dev/kem on UNIX to get CPU utilization information on UNIX systems. Those skilled in the art will recognize that similar calls exist on other operating systems.

void System_network_bandwidth (bandwidth b, accessnetwork a)

The method System_network_bandwidth (bandwidth b, accessnetwork a) determines network bandwidth between a client 30 and the primary server 32 using access network “a”. The bandwidth is calculated by sending a packet of known size S to the primary server 32 from the client 30, getting the same size packet back, and then dividing the packet size S by the time it took to get the packet. This computation preferably is performed in the operating system for greater accuracy.

Void sys network_load_latency(accessnetwork a, latency I)

The method sys_network_load_latency(accessnetwork a, latency l) uses Internet Control Message Protocol (ICMP) to determine network latency. A client periodically sends an ICMP packet to a server and uses the returned values to keep an average value for latency over time. A system administrator can set the frequency with which this operation is performed.

Void Network_uptime(Netuptime nu, accesslink a)

The method Network_uptime(Netuptime nu, accesslink a) determines the percentage of time that a network connection between a client and a server is up. If an ICMP packet returns, then the system assumes that the network is up, otherwise it is down.

3.3 Collection and Dissemination of Application Attributes

In order to make load balancing decisions, measured application attributes must be made available to the load balancing algorithms. The application provisioning optimization is run from the server. The network switching optimization can be run from the server and the client. There are a variety of ways the client and the server can dynamically profile the application attributes.

For example, the system attributes of a requesting client can be obtained in the messages from the client by the load balancing algorithms at the server. The server can store its own system attributes.

The client can keep information on A(W), A(C), A(S), V(W), V(C) and V(S) locally based on the currently running Mervlet application. In addition, a client device may have a plurality of network interfaces. During think times, a separate application on the client may collect information on A(C) on the different networks. This operation preferably is performed in an energy conserving fashion and with care not to overload the battery for the client. A(W) can be collected for each network by adding A(S) and V(C) for the Mervlet across each network interface. Each of the measured A(W) values can be stored in a vector, which is used for application provisioning and network switching decisions.

Alternatively, a client may collect information on A(C) from other clients on a common network that are using the same base stations or access points for communicating with the server. W, C and S can be measured per application or per user per application and stored in a client cache. The client cache can be synchronized with other clients, for example, through the server. It is assumed that the server knows which clients share the same access point or base station. The server will aggregate information for all the clients that share the same base station. The client cache is then sent to the server periodically at a frequency that is set by a system administrator. The period is set by a systems administrator. The server aggregates the data and sends this information plus a smoothing interval to the client when the client requests it. The smoothing interval is a predetermined value indicative of the time that must pass between successive load balancing optimizations.

The client cache can also be synchronized directly between clients. In this case, each client broadcasts the cached information to other clients through an ad-hoc network such as Bluetooth, IRDA or 802.11b. Such a broadcast messages do not have to propagate through the network for communicating between the client and the server. Instead, the clients individually aggregate data. A smoothing interval may be fixed by the system administrator or the clients can employ a distributed consensus algorithm to come to an agreed upon smoothing interval.

A server can obtain the measured performance attributes, including the measured mean and variance of wait, communication and server times, for a Mervlet whenever the Mervlet is run on the server. A system administrator can select the number of times that a Mervlet must run, for example ten iterations, before there is enough measured data about the performance attributes to use the dynamic profiles.

3.3.1 Collecting Modes

Performance attribute values for a Mervlet may be collected either per user or per user per application or per user per application per device. If a device measures and stores performance attributes per application, a load balancing algorithm may use this information independent of the user. In addition, a device may measure and store performance attributes per user per application to allow load balancing algorithms to be tuned to the profiles of different users.

It may be desired to minimize the overhead associated with the mechanism for recording events. Accordingly, the collecting of the performance and system attributes should be non obtrusive from a memory and processing perspective. Since the memory requirements for saving the data for each of the application attributes are relatively minimal, writing this data to memory and reading the system clock should be non obtrusive. For example, assuming that user interface events occur from about 500 milliseconds to about one second, a Java implementation of the Mervlet application environment that support a system clock with about 1 millisecond granularity would allow for the measurement of user interface related events with negligible overhead.

3.4 Load Balancing Algorithms

The Mervlet application environment can load balance a Mervlet at application load time and runtime using two different optimizations based on its application attributes and system attributes: application provisioning and network switching. Specifically, when a user requests a Mervlet, the module PolicyMervlet of the Mervlet engine will decide where to run the Mervlet and which access network to use for communication. Likewise, during runtime, the Mervlet engine may determine to relocate the Mervlet or switch access networks to improve user perceived performance.

3.4.1 Application Provisioning Optimizations

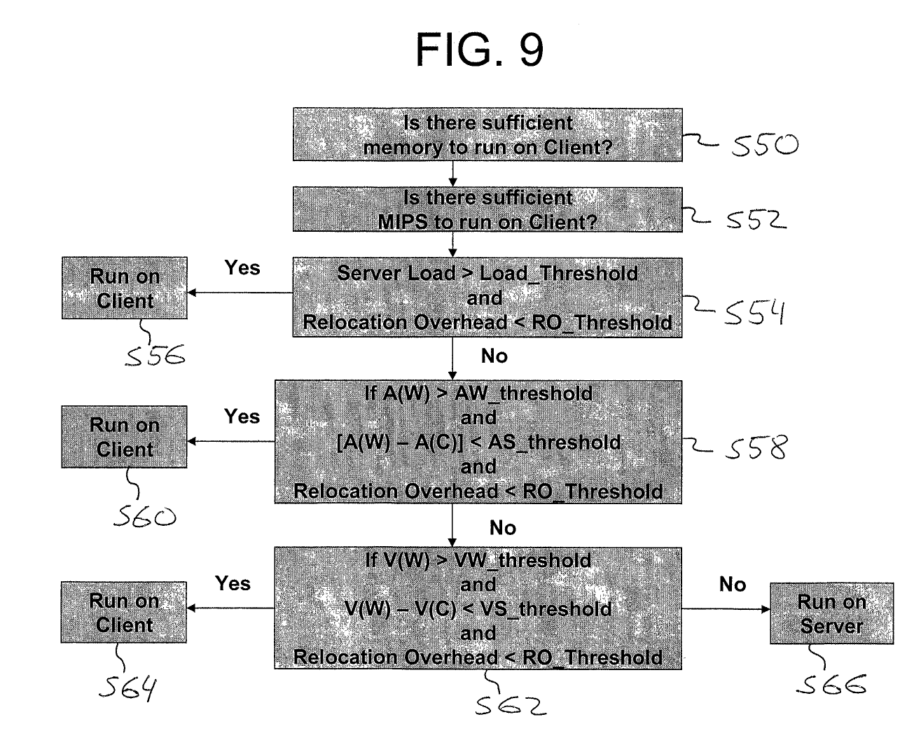

Referring next to FIG. 9, an example of an implementation of an application provisioning optimization is shown using a decision tree. This application provisioning algorithm is run from the server and is equally applicable at load time and runtime of an application.

The application provisioning algorithm is based on mean wait times W, including mean communication times C and server computation times S, of an application. By moving the Mervlet from a server 32 to a requesting client device 30, it is possible to reduce the communication time C to about zero. First, the algorithm determines if the client requesting content from the Mervlet has sufficient memory to run the Mervlet using information about the client obtained from the request in step 50. Likewise, the algorithm determines if there the client has sufficient processing power, as measured by its MIPS rating, to run the application in step 52.

Next, the algorithm determines whether the computation load on the server, as measured by its CPU utilization, is greater than a predetermined Load_threshold value in step 54. Also, it determines whether the relocation overhead associated with moving the Mervlet from the server to the client is less than a predetermined RO_threshold value in step 54. The relocation overhead can be calculated based on the size of the Mervlet using a relationship set by the by system administrator. If both conditions are met, then the algorithm instructs the server to move the Mervlet to the client for execution thereon in step 56. This sequence helps improve the perceived performance of the Mervlet when the server becomes too busy to timely process the Mervlet by moving the Mervlet on the client.

Otherwise, the algorithm determines whether the mean wait time for the Mervlet is greater than a predetermined AW_threshold value in step 58. If this condition is met and the mean server computation time, as measured by difference between the mean wait time and the mean communication time, is less than a predetermined AS_threshold value and the relocation overhead is less than the predetermined RO_threshold value in step 58, the algorithm instructs the server to move the Mervlet to the client for execution thereon in step 60. This step helps improve the perceived performance of the Mervlet when the wait times for user interface events of the Mervlet are too great by relocating the Mervlet to the client as long as the server computation time following the move is not too great.

Alternatively, the algorithm may determine to relocate the Mervlet if the mean wait time is greater than a predetermined threshold value and the mean communication time is greater than the mean server computation time.

Likewise, the algorithm determines whether the variance wait time for the Mervlet is greater than a predetermined VW_threshold value in step 62. If this condition is met and the variance server computation time, as measured by difference between the variance wait time and the variance communication time, is less than a predetermined VS_threshold value and the relocation overhead is less than the predetermined RO_threshold value in step 62, the algorithm instructs the server to move the Mervlet to the client for execution thereon in step 64. This step helps improve the perceived performance of the Mervlet when the wait times for user interface events of the Mervlet are too great by relocating the Mervlet to the client as long as the server computation time following the move is not too great. Otherwise, the Mervlet is run on the server in step 66.

Alternatively, the application provisioning algorithm can discount A(S) in its decision making if A(S) is much smaller then A(C). Otherwise, if S is about the same as C, then a scaling factor, SF, can be used to estimate A(S) on the device. The SF is the ration of the SpecInt on the server divided by the SpecInt on the device, where SpecInt is a known benchmark for comparing processors speeds.

Those skilled in the art will recognize that other implementations for the Mervlet provisioning algorithm are possible using the wait times for an application. For example, other algorithms that omit the step of comparing mean and variance of the wait time are possible.

5 3.4.1.1 Application Provisioning at Request Time

When a request is received from a client device at a server for a Mervlet, the request has the following structure:

URI

MIPS Rating for Client

Mean and Variance of CPU Utilization for Client

Available Device Memory and Persistent Storage for Client (smoothed over a time period)

{Performance Attributes, Data Size for Application }

The performance attributes of the Mervlet are kept in a file on the client and are indexed by a Mervlet URI, and optionally by the user.

The module PolicyMervlet on the server then looks into the server's own performance database and retrieves the following data:

Mean and Variance of CPU Utilization for Server

Mean and Variance of Network Bandwidth and Latency for Each Access Link Attached to Server

{Performance Attributes, Data Size for Application }

The application provisioning algorithm can choose the device the Mervlet is to run on using the application attributes obtained from the client or the server or a combination thereof.

If a server is attempting to load balance a new Mervlet or a Mervlet whose performance attributes are not fresh, it can obtain values for the performance attributes from a recent run of the Mervlet on another device in the network or it can use cached values of performance attributes for a similar application on a similar device and network that it has stored. The freshness criterion is set by the system administrator.

3.4.1.2 Application Provisioning at Runtime

In order to load balance a currently running Mervlet, the requesting client determines if its performance has been degraded beyond a certain threshold and then sends this information to the server. Specifically, while the Mervlet is executing on a server and a client is accessing it from a client device, the client monitors mean and variance wait times for all user interface events from the client. If either A(W) or V(W) reaches a predetermined threshold, then the client sends a message to the server containing the following information:

MIPS Rating for Client

Mean and Variance of CPU Utilization for Client Available Device Memory and Persistent Storage for Client (smoothed over a time period)

{Performance Attributes}

The server then determines if the Mervlet should run on the client instead. If so, the Mervlet and its performance attributes are moved to the client. The server may save the state of the Mervlet before it is shutdown and relocated to allow the client to resume its execution using the save state.

3.4.2 Network Switching Optimizations

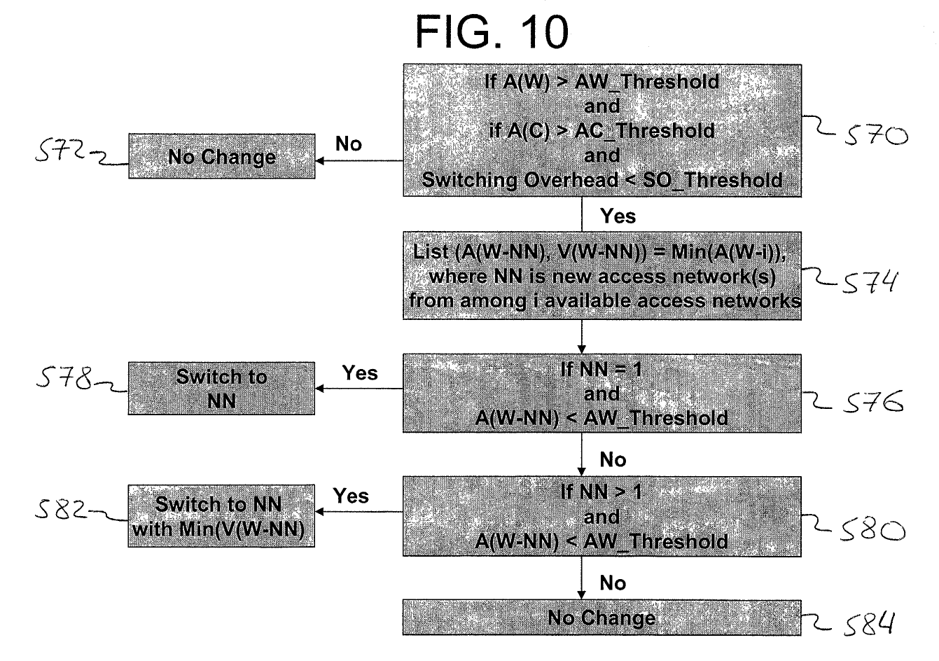

An implementation of a network switching algorithm is shown using a decision tree in FIG. 10. This network switching algorithm can be run from the server and the client. Assuming that a client and server can communicate using a plurality of access networks, the network switching algorithm can switch access networks in order to the lower the mean and variance wait times. A user can install various network switching algorithms on a client device from a server or from another device.

First, in step 70, the network switching algorithm determines whether the mean wait time for the Mervlet is greater than a predetermined AW_threshold value and if the mean communication time for the Mervlet is greater than a predetermined AC_threshold value using the current access network. If these conditions are met and the network switching overhead is less than the predetermined SO_threshold value, the network switching algorithm will attempt to switch access networks in steps 74-82. The network switching overhead can be calculated based on the size of the Mervlet using a relationship set by the system administrator. Otherwise, the current access network remains in use in step 72.

Next, in step 74, the algorithm calculates the mean and variance wait times for the application across all available access networks. It then identifies the minimum mean wait time for the group of available access networks. If the minimum mean wait time is less than a predetermined AW_threshold value and only one access network NN matches it in step 76, then the algorithm instructs the device to switch to the access network NN in step 78.

If the minimum mean wait time is less than a predetermined mean threshold value and two or more access networks match it in step 80, then the algorithm selects the access network from among the identified group having the lowest variance wait time in step 82. Otherwise, if none of these conditions for switching access networks is met, the current access network remains in use in step 84.

Alternatively, the algorithm can switch access networks if it finds an access network whose mean wait time is less than the mean wait time for the currently used access network by a predetermined threshold value, T-meanwait. If the mean wait times are approximately the same on all access networks, but there exists an access network where the variance of the wait time is less than the variance wait time for the currently used network by a predetermined threshold, T-varianceMeanwait, then the algorithm can switch to this network.

3.5 Utilization Smoothing

Utilization smoothing is a technique that can prevent thrashing during load balancing. In particular, the Mervlet application environment only allows N network switching events per time period T. These parameters can vary with individual implementations of the system and can be set by a system administrator of a network. The following algorithm for clients can be used to determine the smoothing interval for the network switching algorithm.

Each client has a list of switches made in the time period T by each of its peers. The peer group is created dynamically or can be requested from the server. Each time a client switches networks it broadcasts that information to its neighbors using an adhoc network. The switching algorithm is run only if the number of switching events in time period T is less than N. However, when the link itself fails, the algorithm may be configured to switch networks immediately. Alternatively, a server may keep a list of switches made recently and send this information to each client requesting updates of application attributes.

4. Fault Tolerance Scheme

The Mervlet application environment allows a system administrator to choose the types of failures that the system should tolerate using two components: a Mervlet engine 10 that can recover from crash and a reliable messaging system 20 that guarantees that messages in transit will be delivered with at least once semantics. The reliable messaging system 20 may be configured as follows: no fault tolerance, recoverable from client and network faults, and recoverable from client, network and server faults.

For example, during request processing from multiple clients or a response from a server, the network connection to between a server and a UCD may be lost. If required, on reconnection, the server will automatically run the decision algorithm to determine where to run the Mervlet. In addition, the system administrator can choose whether or not to fault tolerant system components. The tradeoff is that fault tolerance has performance implications that must be weighed against the reliability that is required. The fault tolerance methodology characterizes the various faults in a mobile system based on cost associated with component recovery and its associated cost. It then allows a system administrator to choose the components to recover from.

4.1 Recoverable Mervlet Engine

The Mervlet engine 12 periodically stores its state on persistent storage, including a list of all currently executing Mervlets 10 and the most recent Mervlet context for each. The list may also contain the priority of each application. In addition, the engine 12 can at any time call the method Save( ) on a Mervlet 10 to save its application state into persistent storage.

The Mervlet engine 12 can restore its own state to restart the set of Mervlets that it was executing on a device at the time of a crash. The Mervlet engine 12 will restart each Mervlet 10 on its list one at a time. The order for restarting the Mervlets may depend on their priorities. A Mervlet 10 can register the method Restore(ApplicationContext) with the runtime engine 12 when the Mervlet is restarted following a device failure. The data object ApplicationContext includes data from the runtime engine's list that identifies the application and its context. The method Restore(ApplicationContext) can implement Mervlet specific recovery operations, including reading the state of local communication buffers to identify the communication state of the reliable messaging system 20 for the Mervlet on the client 30. It can also query the communication state of the reliable messaging system 20 for the Mervlet on the server 32. The method can return control to the Mervlet engine 12 after a Mervlet 10 has been restored.

4.2 Reliable Messaging System

The messaging system 20 of the Mervlet application environment can utilize various messaging protocols to deliver the contents of a Mervlet and Mervlets themselves in a network and is not limited to the HTTP protocol. For example, types of messaging protocols that have been found useful include one-way and request-response protocols, which could be synchronous or asynchronous. The messaging system 20 may be fault tolerant to ensure that transactions in progress will be preserved. However, a reliable messaging system is not responsible for recovering Mervlets themselves following device failures.

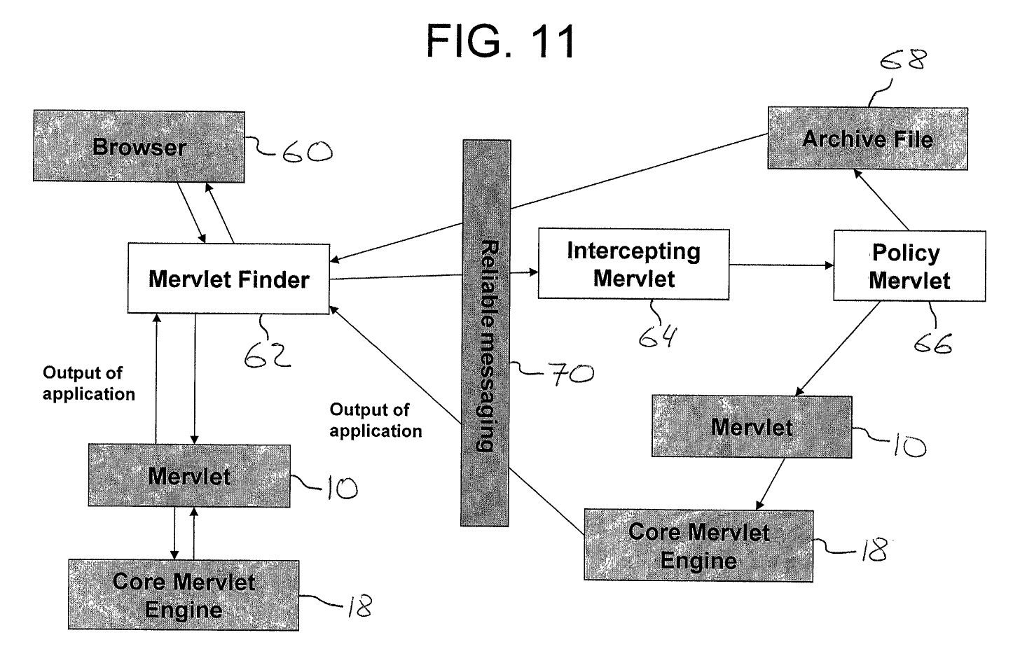

In particular, a reliable messaging system 70, shown in FIG. 11, has a queue 72 on the client side such that all outgoing communication from a client 30 is buffered. The buffer has a user configurable size. Also, each message is tagged with a unique sequence number and a reply is sought for each element. If a reply is not received, the message is retransmitted until a reply is received. When the reply is received, the appropriate buffered message is released from the system.

The reliable messaging system 70 may be implemented such that a reply is tied either to the underlying operating software of a device or to a higher level event in the Mervlet 10. For general application communication, the generic form is used where the reply is tied to the underlying software. For system level reliable communication, the buffering mechanism is tied to the request being received by the Mervlet engine for lower overhead.

In order to implement the reliable messaging system 70, the following API is provided:

void Reliable_async_send(Endpoint to, Endpoint From,
MessageData Data, Reliability Type, Callbackmethod cm)

The “to” field identifies the receiver. The “from” field identifies the sender. The “data” field is the serialized data being sent. The “type” is either application level or system level. A callback method is called when an acknowledgement is received. Using this API, the system can guarantee at least one delivery of a message.

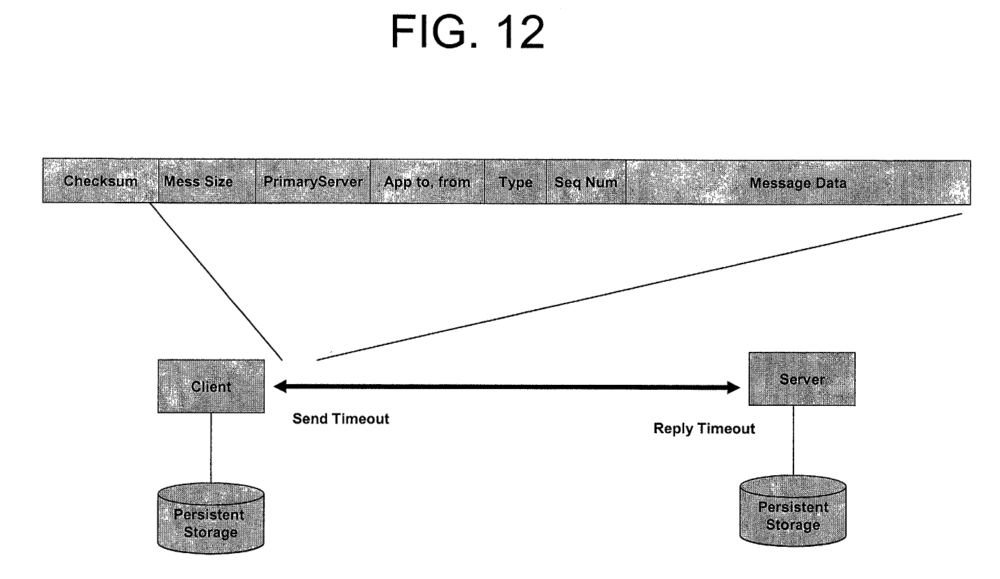

The message format for the reliable messaging system 70 is shown in FIG. 12. It has a total of six fields, where the first four are fixed size, the data segment is variable size, and the checksum is variable and computed over all the fields. It is possible to relocate a Mervlet in a network using the reliable messaging system 70 by including the Mervlet itself in the data payload of individual messages.

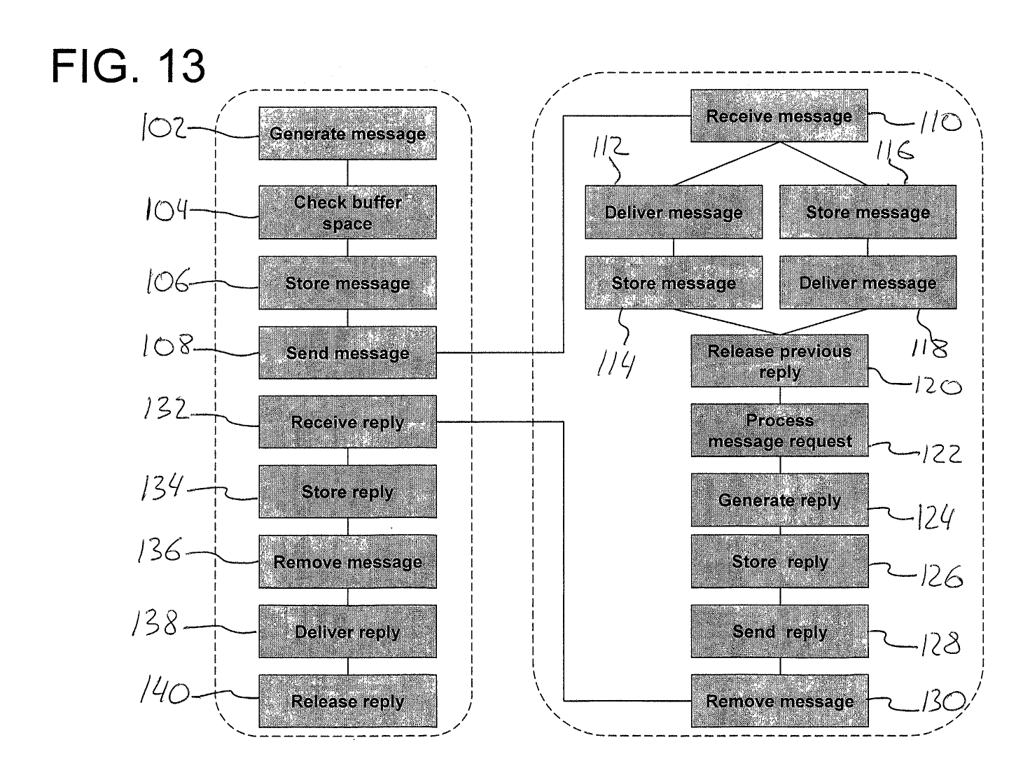

In operation, as shown in FIG. 13, each time a client application sends a message to a Mervlet on a server in step 102 by calling the method Reliable_async_send, the reliable messaging system 70 on the client 30 checks to see if there is free buffer space on a persistent storage of the client, such as a flash memory or micro-drive, in step 104. The maximum buffer space is set to a predetermined value, MAX_BUF, by the system administrator. If there is sufficient buffer space available, the message is buffered and a buffer manager of the reliable messaging system 70 attaches a sequence number to the message in step 106. All messages are sent with unique sequence numbers between two pairs of machines. Once the message is buffered, the call can return to the client application. The call does not return to the client application until the message has been buffered to a persistent storage. After the call returns, the client application is assured that the message will be delivered to the appropriate Mervlet even if the client device or network fails.

Periodically, a buffer management thread wakes up and sends the buffered messages to the server 32 in step 108 and waits for replies to messages previously sent. Each message has a predetermined timeout value associated with it. If a message reply has not been received within the timeout period, then the message is resent. This process continues until a reply has been received. The buffer management thread is only triggered when an access network 38 is up and a path to a primary server 32 has been established.

On receipt of a request message on the server in step 110, the system administrator can choose how the reliable messaging system 70 should process and deliver the message to the Mervlet on the server. For example, the system can immediately deliver the message to the Mervlet in step 112 and then store the message to a persistent storage in step 114, such as a hard disk. This increases the time the message is not in a “safe” state, but it gives the Mervlet quick access to the message. Alternatively, on receiving the message, the reliable messaging system 70 on the server 32 can log it in a persistent storage in step 116 and then deliver it to the Mervlet in step 118. The Mervlet then processes the message (step 122) and generates a reply (step 124). It also signals to the reliable messaging system 70 that it has responded. The system logs the reply in step 126 and then attempts to send it to the requesting client in step 128. At this point, the request message is removed from the persistent storage buffer on the server in step 130.

The client on receiving the reply (step 132) immediately stores the reply in a buffer on persistent storage (step 134). It then finds the matching request message that was sent to the server and removes it from the buffer in step 136. Next, the client attempts to deliver the reply to the appropriate callback method from the client application in step 138. Once the callback method is called, the reply is released in step 140. On the server, the buffer for the reply will be released when the next message is received from the same client with a higher sequence number in step 120. If a duplicate message is received by the server, then it is discarded. The size of the acknowledgement buffer is set by the systems administrator to ACK_BUF.

4.2.1 Finding a Connection to the Primary Server

The reliable messaging system 70 manages the connection between a client device 30 and a server 32. The system periodically wakes up and performs the following task. It checks to see if the primary server 32 can be contacted through any of the clients access networks, such Bluetooth, 802.11b (Wi-Fi) wireless, IRDA, and General Packet Radio Service (GPRS) mobile telephone networks 802.11b. It does this by sending an ICMP Ping to the primary server 32. The first access network that provides a match is used for further communication between the client 30 and the server 32. The reliable messaging system 70 also wakes up its buffer management thread and tells it which protocol to use to communicate with the server 32.

4.2.2 Configurability

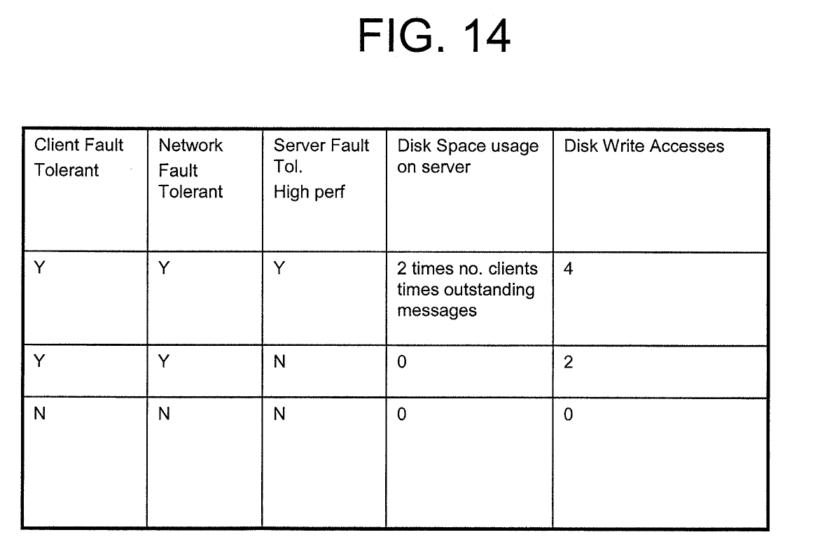

Fault tolerance comes at a cost since all writes to a disk cost time and disk space. Referring next to FIG. 14, several configurations for the implementation of the reliable messaging system 70 are shown. The first row describes a technique where messages being logged on the server 32 and client 30, the second describes messages are logged solely on the client 30, and the third row describes a technique where no messages are logged. The first two options offer the following alternatives for fault tolerance. If a user desires to lower the runtime costs and is willing to spend more time in recovering an application, then the second option may be considered. The first option has higher runtime costs because messages are logged on the client and the server, but the benefit to the user is that the recovery for the application using the reliable messaging system is made more robust.

4.3 Handling Failures

When a server 32 recovers from a failure, it looks at the buffer list on its persistent storage, which was stored in step 106 shown in FIG. 13. The reliable messaging system 70 assumes that data on the persistent storage of the device is not destroyed, but data in main memory of the device is destroyed. If the list contains a message from a client 30, then the reliable messaging system 70 assumes that the request has not been processed and attempts to deliver the message to the appropriate Mervlet on the server. Likewise, if the server 32 finds a buffered reply after recovery from a crash, the system sends it to the appropriate destination client 30.

In order to successfully recover the entire Mervlet application environment from a crash, the following sequence of recovery operations is used:

1) The reliable messaging system 70 comes to a consistent state.

2) The caching infrastructure, described below, is brought to consistent state.

3) The Mervlet engine 12 comes to a consistent state.

4) The individual Mervlets 10 are sequentially brought to a consistent state.

5. Disconnected Mode Computing A client device 30 may be “disconnected” from a server 32 or other devices for two reasons: a network failure or a voluntary move by the system administrator or user, for example to reduce network bandwidth usage. The Mervlet application environment provides two features to support disconnected operation: asynchronous reliable messaging and Mervlet caching.

Asynchronous reliable messaging allows messages to be queued at either the client 30 or the server 32 when a network connection is not present between the client and server. When an application sends a message, it is buffered or queued locally, as described above. Messages are sent only when a network connection is established. When a network connection is re-established, the asynchronous reliable messaging system will resend the messages waiting in the buffer queue. The reliable messaging system 70 can also save the message queues in persistent storage so that device and server failures can be tolerated, as described above.

The second mechanism for disconnected mode computing calls for storing Mervlets in a local cache on the client device 30. The cache memory is managed by a cache manager 22, shown in FIG. 1. The cache is accessible to a browser or other client application even without a network connection. If the client 30 is disconnected, the Mervlet on the cache can still serve the local browser. In addition, the local browser can still request Mervlets from the local cache.

The cache can be managed in a variety of ways, but preferably it allows intelligent pre-fetching using techniques such as hoarding. The Mervlet caching mechanism allows the client 30 to delegate a variety of cache management decisions to a server 32 in situations where the server has more knowledge about future Mervlet accesses, for example in a collaborative setting or in a setting where information is being proactively pushed to the client device 30. Therefore, a cache management policy can be set by the client 30, by the server 32 or a combination of both. At runtime, a server 32 can update the cache replacement and write policy for each of the Mervlets 10 stored on the cache of the client device 30.

Moreover, those skilled in the art will recognize that the cache manager 22 can implement caching algorithms that treat code and data separately if they so desire. Also, the cache may consider device characteristics and individual user usage profiles into cache management algorithms.

One implementation of the cache manager 22 calls methods on a pre_fetch class to implement prefetching, a cache_miss class to implement handling of cache misses and a cache_write class to implement data writes to the cache.

A pre-fetch operation may be server initiated or client initiated. For a server-initiated pre-fetch, the server 32 sends a pre-fetch notification to the client 30, which sends back the cache state vector. The server then sends a new set of documents and optionally a new replacement policy to the client. The server 32 also makes a request to run a Mervlet 10 on the client device 30. When the Mervlet 10 is executed on the client 30, it sends back the cache state vector to the server 32. The server 32 then sends a set of cache objects to the Mervlet 10 and a replacement policy. Next, the Mervlet 10 calls back to the server 32 to load the class for the new replacement policy.

In order to handle a cache miss, the cache manager 22 on the client 30 sends a request to the primary server 32 indicating that a document is missing and a vector of the local cache state when a miss occurs. The vector includes the size of cache and any changes to the hash table for the cache since last update to server. The primary server 32 the sends back the requested document. It may also send back other pre-fetched documents and a replacement policy. The client 30 uses this new replacement policy on its cache. The following pseudo code that illustrates this method:

Void handle_cache_miss( )

Send(primary_server, hash_vector_diff, Uri);
Receive(cache_objs, new_policy)

if(new_policy) load_class(new_policy);

return;

If the client 30 requests a list of new Mervlets 10 for its cache, the server 32 sends them back and optionally a replacement policy. Once again, the client will proactively download the new class that implements replacement.

The write policy for a local cache on the client 30 may be changed by the cache manager 22 using a new class that is downloaded from a server 32. For each element in the cache, the server 32 can attach a policy on how to handle dirty or written objects when an object is forced to leave the cache. Accordingly, the caching system is configurable be selecting whether the system may perform caching or not. This is a dynamic or runtime choice. In addition, the caching system itself is dynamically extensible in three areas: replacement policy, prefetch policy and modified data management policy.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

We claim:

1. A mobile application environment for a mervlet application forming part of a mobile communication network comprising at least one access network, said environment comprising:
said mervlet including instructions to create a web page with dynamically generated content, said mervlet capable of executing on at least one of a local node and a remote node of said network;
a set of application attributes for the mervlet including performance attributes characterizing the user interface of said mervlet;
a set of security attributes for the mervlet defining a security context in which to execute said mervlet;
a mervlet engine operative to manage a lifecycle of said mervlet, said mervlet engine comprising:
a core interpreter module operative to execute said mervlet in said security context;
a policy module operative to determine whether to relocate said mervlet and said application attributes and said security attributes between said local and remote network nodes and to switch said at least one access network using said application attributes to improve a user perceived performance of said mervlet;
a cache manager agent operative to manage cache memory of said local and remote network nodes for receiving and storing said mervlet; and
a messaging system operative to deliver content of said mervlet and said mervlet across said network.
